(19) United States
(12) Patent Application Publication
(10) Pub. No.: US 2024/0018945 A1
(43) Pub. Date: Jan. 18, 2024

(54) LABYRINTH SEAL DEVICE FOR AN AIR PASSAGE FOR COOLING AIR OF A COOLING SYSTEM OF A GENERATOR OF A WIND POWER INSTALLATION AND USE THEREOF, AND AIR PASSAGE, GENERATOR AND WIND POWER INSTALLATION

(71) Applicant: Wobben Properties GmbH, Aurich (DE)

(72) Inventors: Hussam Daboul, Südbrookmerland (DE); Steffen Busemann, Bremen (DE); Malte Koppe, Bremen (DE)

(21) Appl. No.: 18/351,324

(22) Filed: Jul. 12, 2023

(30) Foreign Application Priority Data
Jul. 14, 2022 (EP) 22185015.9

(51) Int. Cl. F03D 80/60; F16J 15/447

(52) U.S. Cl. CPC F03D 80/60; F16J 15/447; F05B 2240/57

(57) ABSTRACT

A labyrinth seal device for an air passage, wherein the air passage is preferably an air outlet or an air inlet, for cooling air of a cooling system of a generator of a wind power installation the labyrinth seal device having a first labyrinth seal wall and a second labyrinth seal wall arranged spaced apart from the first labyrinth seal wall, wherein the first and second labyrinth seal walls form a labyrinthine sealing section which is configured to seal the generator with respect to dirt and/or water from a surrounding area and to guide cooling air from the generator into the surrounding area, wherein there is arranged within the sealing section an air directing device which is configured to direct the cooling air in flow-optimized manner out of the generator into the surrounding area.

### BACKGROUND

### Technical Field

The disclosure relates to a labyrinth seal device for an air passage for cooling air of a cooling system of a generator of a wind power installation.

Furthermore, the disclosure relates to the use of a labyrinth seal device for the flow-optimized sealing of an air passage for cooling air of a cooling system for a generator of a wind power installation.

The disclosure relates further to an air passage, to a generator, and to a wind power installation.

### Description of the Related Art

For cooling a generator, the generator, when it is air-cooled, frequently has one or more air passages as part of the cooling system. Such a generator generally has as the air passage at least one air inlet and at least one air outlet. In the operating state, air from the surrounding area is guided as cooling air through the air inlet into the generator interior in order to cool the generator. In the operating state, warmed cooling air from the generator interior is guided through the air outlet into the surrounding area in order to cool the generator. The cooling system frequently has one or more fans which convey the cooling air from the surrounding area into the generator and through the generator, and convey the warmed cooling air out of the generator into the surrounding area.

In order to achieve as high a cooling capacity as possible with the cooling system, the cross-section of the air passages through which the cooling air for cooling the generator flows is to be as large as possible. Opposed to this, however, is the fact that the generator interior is to be sealed with respect to the surrounding area such that no dirt, water or other objects from the surrounding area which reduce the service life of the generator, increase the maintenance requirements and possibly stand in the way of controlled operation of the generator can enter the generator interior.

In the case of a stationary seal, for example, a rubber seal, such as an O-ring, comes into consideration for sealing against dirt, water and the like. If, on the other hand, a rotating component, for example, is to be sealed with respect to a stationary component, rotary shaft seals, which can ensure sealing against dirt, water and the like, are frequently used. However, if the seal is additionally to allow cooling air to pass the seal, neither rubber seals such as O-rings nor rotary shaft seals are the suitable means of choice.

A seal which permits sealing against dirt, water and the like and which at the same time can allow cooling air to pass is a labyrinth seal device. Such a labyrinth seal device is used not only as a seal between two fixed components but also for sealing between a stationary component and a rotating component.

Owing to its function, such a labyrinth seal device is of multi-stage form. Depending on the stage, shaped elements which prevent the ingress of dirt, water and the like engage with one another (intermeshing). However, the intermeshing has the fundamental disadvantage that the flow path of the sealing section is thus lengthened and the flow resistance is accordingly increased, which in turn minimizes the cooling capacity or makes substantially more powerful cooling systems, that is to say more powerful fans, necessary. Such more powerful cooling systems are generally expensive to acquire and to operate and stand in the way of a compact construction of generators.

Furthermore, the air passages are preferably to be arranged such that the cooling air, with as little resistance as possible, can be guided from the surrounding area into the generator interior, can be guided through the generator interior and can be discharged from the generator interior into the surrounding area. The structural design of generators, in particular the compact structural design thereof, generally stands in the way of cooling air being guided through the air passages with as little resistance as possible. The cooling air, due to the installation space, must frequently be guided around corners and edges. These changes in the flow direction likewise increase the flow resistance and thus result in a minimized cooling capacity.

### BRIEF SUMMARY

A labyrinth seal device and the use thereof, an air passage, a generator and a wind power installation which minimize or eliminate the above-mentioned disadvantages. In particular, provided is a labyrinth seal device and the use thereof, an air passage, a generator and a wind power installation which seal a generator interior of a generator with respect to the surrounding area of the generator from dirt, water and the like, and at the same time of permitting a cooling capacity by means of a comparatively low-power cooling system, or of improving the cooling capacity in a cooling system that is unchanged.

According to a first aspect, the labyrinth seal device has a first labyrinth seal wall and a second labyrinth seal wall arranged spaced apart from the first labyrinth seal wall, wherein the first and second labyrinth seal walls form a labyrinthine sealing section which is configured to seal the generator with respect to dirt and/or water from a surrounding area and to fluidically connect the surrounding area of the generator with a generator interior of the generator in order to cool the generator. The sealing section has an air directing device which is configured to direct the cooling air in a flow-optimized manner through the sealing section.

The air passage is configured to guide cooling air of a cooling system of a generator. In particular, the air passage is configured to fluidically connect the surrounding area of the generator with the generator interior. The air passage is preferably an air outlet, through which cooling air from the generator interior exits into the surrounding area, and/or an air inlet, through which cooling air from the surrounding area enters the generator interior. It can further be preferred that the air passage is configured to establish a fluidic connection within the generator interior.

The air passage preferably extends between two openings, wherein cooling air is able to enter through one of the two openings (inlet opening) and cooling air is able to exit through the other of the two openings (outlet opening). In particular, it is provided that one of the two openings, as the so-called external opening, opens the passage channel to the surrounding area of the generator in the installed state. It is further preferably provided that the other of the two openings, as the so-called internal opening, opens the passage channel to the generator interior of the generator in the installed state.

The air passage can in particular be in the form of a channel. Preferably, the air passage is tubular. The tubular air passage can in particular have a circular and/or a triangular and/or rectangular cross-section. In particular, it can be provided that the air passage is in the form of a ring segment or part-ring segment.

Where the air passage is an air inlet, the air passage is configured to guide cooling air from the surrounding area of the generator into the generator into a generator interior. In the case of an air inlet, air from the surrounding area is supplied to the generator for cooling the generator. It will be appreciated that in preferred embodiments of the air passage as an air inlet, the air from the surrounding area which is supplied to the generator through the air inlet for cooling is cleaned, for example filtered, and optionally adjusted to a desired cooling temperature which permits optimal operation of the generator.

If the air passage is an air outlet, the air passage is configured to guide the cooling air warmed by the generator out of the generator, the generator interior, into the surrounding area of the generator.

Preferably, the air passage has the labyrinth seal device. In particular, it can be provided that the air passage forms the labyrinth seal device or the air passage is formed as the labyrinth seal device in some portions. Preferably, the labyrinth seal device is arranged or formed between the above-mentioned two openings, the inlet opening and the outlet opening, in particular the internal and external openings.

The labyrinth seal device is preferably configured to guide cooling air of a cooling system. In particular, the labyrinth seal device can be configured to fluidically connect the surrounding area of the generator with the generator interior. It can further be preferred that the labyrinth seal device is configured to establish a fluidic connection within the generator interior. The labyrinth seal device can in particular be in the form of a channel. Preferably, the labyrinth seal device is tubular. The tubular labyrinth seal device can in particular have a circular and/or a triangular and/or rectangular cross-section. In particular, it can preferably be provided that the labyrinth seal device is in the form of a ring segment or part-ring segment. The labyrinth seal device preferably extends between two openings, wherein cooling air is able to enter through one of the two openings, which can also be called the inlet opening, and cooling air is able to exit through the other of the two openings, which can also be called the outlet opening.

It can further be preferred that the labyrinth seal device is the air passage or forms the air passage. In particular, it is provided that one of the two openings of the labyrinth seal device is the so-called external opening, which opens the labyrinth seal device to the surrounding area of the generator in the installed state. It is further preferably provided that the other of the two openings of the labyrinth seal device is the so-called internal opening, which opens the labyrinth seal device to the generator interior of the generator in the installed state.

The labyrinth seal device has first and second labyrinth seal walls, which are arranged spaced apart from one another. In particular, it is provided that the distance between the first and second labyrinth seal walls is constant. It can also be preferred that the distance between the first and second labyrinth seal walls can also vary in preferred embodiments. Preferably, one of the two labyrinth seal walls is formed by a stationary component and the other of the two labyrinth seal walls is formed by a rotating component. In particular, it is provided that the stationary component is a component of the stator and the rotating component is a component of the rotor.

It can be preferred that the labyrinth seal device has more than the first and second labyrinth seal walls. In particular, it can be provided that the labyrinth seal device has a third and/or fourth labyrinth seal wall. Preferably, the third and fourth labyrinth seal walls are arranged spaced apart from one another, in particular in parallel and spaced apart from one another. It is further preferred that the third and/or fourth labyrinth seal wall/walls extends/extend between the first and the second labyrinth seal walls.

Preferably, the first and the second and/or the third and/or the fourth labyrinth seal walls form a channel. It can further preferably be provided that the first and the second and/or the third and/or the fourth labyrinth seal walls are tubular. Where the labyrinth seal device, in the preferred manner, is tubular with a circular cross-section, it will be appreciated that the first and second and/or the third and/or the fourth labyrinth seal walls each form a tube wall portion of the tubular labyrinth seal device.

Preferably, the first and second and/or the third and/or the fourth labyrinth seal wall in the form of a tube wall portion extends through 180° in the circumferential direction. Extents in the circumferential direction that differ therefrom are conceivable. In particular, it can be preferred that the first and second and/or the third and/or the fourth labyrinth seal wall in the form of a tube wall portion extends through 60°, 90° or 120° in the circumferential direction. In particular, it can be provided that the first and/or the second and/or the third and/or the fourth labyrinth seal wall/walls is/are annular or semi-annular.

Where the tubular labyrinth seal device has a triangular cross-section, it is preferably formed by the first, the second and the third labyrinth seal walls. Where the tubular labyrinth seal device has a rectangular cross-section, it is preferably formed by the first, the second, the third and/or the fourth labyrinth seal walls.

The first and second labyrinth seal walls form a labyrinthine sealing section. In particular, it can be preferred that a plurality of labyrinth seal walls, preferably the first and the second and/or the third and/or the fourth labyrinth seal walls, form the labyrinthine sealing section. In the case of a labyrinthine sealing section, it is provided that this section forces at least one change of direction upon cooling air flowing along the sealing section. There is a change of direction in particular when the flow direction of the cooling air along the sealing section and the flow direction of the cooling air at the inlet opening of the cooling section differ from one another at least once.

Preferably, the sealing section is configured such that it provides a change of direction of at least 30°, 45°, 60°, 90°, 135°, 180°, 225° or 360° and/or provides at least one change of direction of 30°, 45°, 60°, 90°, 135°, 180°, 225° or 360°. In particular, the sealing section can be configured such that it forces multiple changes of direction upon cooling air flowing along the sealing section. In particular, it can be provided for this purpose that the labyrinthine sealing section is meandering. Preferably, the first and second labyrinth seal walls are each tooth-shaped and/or comb-shaped, so that tooth tips or comb tips of the first labyrinth seal wall extend into tooth troughs or comb troughs of the second labyrinth seal wall and, conversely, tooth tips or comb tips of the second labyrinth seal wall extend into tooth troughs or comb troughs of the first labyrinth seal wall.

The air directing device is preferably curved. The air directing device is in particular convex and/or concave. It can additionally or alternatively be preferred that the air directing device is inclined, in particular arranged at an angle, relative to the flow direction of the cooling air.

The air directing device in particular has a leading edge and/or a trailing edge. Preferably, the air directing device extends between the leading edge and the trailing edge. Preferably, the leading edge is the edge of the air directing device at which the flow of cooling air arrives. The leading edge is in particular the edge at which the cooling air first comes into contact with the air directing device in the flow direction. The trailing edge is in particular the edge of the air directing device at which the flow of cooling air leaves. The trailing edge is preferably the edge at which the air stream of the cooling air breaks away, the cooling air is no longer in fluidic contact with the air directing device. It will be appreciated that the leading edge is arranged upstream of the trailing edge in the flow direction.

Preferably, the air directing device is concave and/or convex, starting from the leading edge. Additionally or alternatively, the air directing device is concave and/or convex up to the trailing edge. Preferably, the air directing device extends between the leading edge and the trailing edge in the installed state along the sealing section. In particular, it is provided that the air directing device is concave and/or convex between the leading edge and the trailing edge. In particular, the air directing device has concave air directing portions and/or convex air directing portions. In particular, the air directing device can have a curvature which is constant along the sealing section. Alternatively, the air directing device can have a curvature which varies along the sealing section. In particular, the air directing device has a portion of constant curvature between the leading edge and the trailing edge. Additionally or alternatively, the air directing device has a portion of varying curvature between the leading edge and the trailing edge.

The disclosure is based on the finding that the cooling air can be guided in a flow-optimized manner along the sealing section by means of the air directing device. The inventors have found that the flow resistance of the sealing section can be minimized by providing an air directing device. This has the advantage that the cooling air for cooling the generator can be supplied and/or guided through and/or discharged. As a result, the generator is cooled substantially better while the cooling capacity of the cooling system remains the same. This increases the service life of generators considerably.

In particular, in the case of such an optimized sealing section, it is also advantageously possible to provide a less powerful cooling system with which the same cooling action of the generator can be achieved. Costs in terms of acquisition and operation can thus be minimized. Furthermore, generators can be made more compact as a result. This facilitates the handling of such generators during assembly and maintenance.

For the advantages, embodiment variants and embodiment details of this aspect of the disclosure and its further developments, reference is also made to the following description relating to the corresponding features of the respective other aspects and their further developments.

According to a preferred embodiment of the labyrinth seal device, it is provided that the air directing device is arranged within the sealing section, in particular spaced apart from the first and/or second labyrinth seal wall. In particular, it is preferred that the air directing device is arranged spaced apart equidistantly from the first and second labyrinth seal walls. It can further be preferred, additionally or alternatively, that the air directing device is in particular arranged spaced apart from the third and/or fourth labyrinth seal wall. In particular, it is preferred that the air directing device is arranged spaced apart equidistantly from the third and fourth labyrinth seal walls. This preferred embodiment in particular has the advantage that the pressure loss is again comparatively lower compared to other variants.

Additionally or alternatively, it is provided according to a preferred embodiment of the labyrinth seal device that the air directing device is formed on the first and/or second labyrinth seal wall or forms the first and/or the second labyrinth seal wall. It can further preferably be provided, additionally or alternatively, that the air directing device is formed on the third and/or fourth labyrinth seal wall or forms the third and/or the fourth labyrinth seal wall. This preferred embodiment in particular has the advantage that it can be manufactured in a less complex and therefore even more simple manner compared to other variants.

Furthermore, it is provided according to a preferred further development of the labyrinth seal device that the air directing device has at least one air directing element. The at least one air directing element is in particular an air baffle.

The at least one air directing element is preferably curved. The at least one air directing element is in particular convex and/or concave. It can additionally or alternatively be preferred that the at least one air directing element is inclined, in particular arranged at an angle, relative to the flow direction of the cooling air.

Preferably, the at least one air directing element is concave and/or convex, starting from the leading edge. Additionally or alternatively, the at least one air directing element is concave and/or convex up to the trailing edge. Preferably, the at least one air directing element extends between the leading edge and the trailing edge in the installed state along the sealing section. In particular, it is provided that the at least one air directing element is concave and/or convex between the leading edge and the trailing edge. In particular, the at least one air directing element has concave air directing portions and/or convex air directing portions. In particular, the at least one air directing element can have a curvature which is constant along the sealing section. Alternatively, the at least one air directing element can have a curvature which varies along the sealing section. In particular, the at least one air directing element has a portion of constant curvature between the leading edge and the trailing edge. Additionally or alternatively, the at least one air directing element has a portion of varying curvature between the leading edge and the trailing edge.

In particular, the air directing device has two, three or more air directing elements. Preferably, the air directing elements are arranged at a distance from one another which corresponds substantially to the distance of the air directing elements from the first and/or second labyrinth seal wall. It can further be preferred that the two or more air directing elements are arranged such that they intersect. Preferably, it is provided that the two air directing elements are arranged in the shape of a cross. In particular, it can be provided that one, two or more air directing elements extend along a first direction of extent, for example in a vertical direction, and one, two or more air directing elements extend along a second direction of extent, for example in a horizontal direction, which is different from the first direction of extent. In particular, it can be preferred that the at least one air directing element has the shape of a cross.

It can be preferred that one or more air directing elements extend between the first and second labyrinth seal walls. Preferably, the one or more air directing elements extend spaced apart from the third and/or fourth labyrinth seal wall. In particular, it can be preferred that the one or more air directing elements extend parallel to the third and/or the fourth labyrinth seal wall.

Additionally or alternatively, it can be provided that one or more air directing elements extend between the third and fourth labyrinth seal walls. Preferably, the one or more air directing elements extend spaced apart from the first and/or second labyrinth seal wall. In particular, it can be preferred that the one or more air directing elements extend parallel to the first and/or the second labyrinth seal wall.

This arrangement has the advantage that the flow of cooling air within the sealing section can be adjusted optimally in terms of flow.

It is further provided according to a preferred further development of the labyrinth seal device that the air directing device has at least two air directing elements, wherein the at least two air directing elements are arranged one behind the other and/or side by side in the flow direction of the cooling air.

This arrangement has the advantage that the flow of cooling air within the sealing section can be adjusted optimally in terms of flow.

According to a further preferred embodiment of the labyrinth seal device, it is provided that the at least one air directing element is curved and/or the at least one air directing element is inclined, in particular arranged at an angle, relative to the flow direction.

According to a further preferred further development of the labyrinth seal device, it is provided that the at least one air directing element is in the form of a part-ring segment which extends preferably through about 90° or 180°, and/or is in the form of a planar element.

Furthermore, it is provided in a preferred embodiment of the labyrinth seal device that the labyrinthine sealing section has at least one deflection region which is configured to guide the cooling air such that the at least one deflection region causes a change in the flow direction of the cooling air.

A deflection region is formed in particular in that a change in the flow direction is brought about in the deflection region. In particular, it is provided that a change in the flow direction in the at least one deflection region takes place about a deflection axis. A deflection axis is here to be understood not as a physical axis but as a virtual axis relative to which the flow direction of the cooling air can vary.

Preferably, it is provided that the sealing section has a plurality of deflection regions. In particular, it can be preferred that the plurality of deflection regions each cause a change in the flow direction about a deflection axis, wherein the deflection axes of the plurality of deflection regions extend parallel to and spaced apart from one another. It can further be preferred that a plurality of deflection regions cause a change in the flow direction about a deflection axis, wherein at least one deflection region causes a change in the flow direction about a deflection axis, wherein the deflection axis thereof is oriented so that it is rotated relative to the deflection axis of at least one deflection axis of another deflection region. Preferably, the sealing section has, for example, a first deflection region, which causes a change in the flow direction about a vertical deflection axis, and a second deflection region, which causes a change in the flow direction about a horizontal deflection axis, so that the horizontal deflection axis is oriented so that it is rotated through 90° relative to the vertical deflection axis.

It is further provided according to a preferred further development of the labyrinth seal device that the at least two deflection regions are configured to bring about a change in the flow direction of at least 90°, preferably of at least 180°, wherein the at least two deflection regions are arranged in series in the flow direction.

According to a further preferred embodiment of the labyrinth seal device, it is provided that air directing elements arranged in a deflection region, in particular at least two air directing elements arranged side by side orthogonal to the flow direction and/or at least two air directing elements arranged one behind the other in the flow direction, form an air directing unit.

Furthermore, it is provided according to a preferred further development of the labyrinth seal device that at least one directing element and/or an air directing unit are/is arranged in at least one or in all of the deflection regions.

According to a further preferred embodiment of the labyrinth seal device, it is provided that the first labyrinth seal wall and the second labyrinth seal wall are arranged stationarily with respect to one another.

Alternatively, it is provided in a preferred embodiment that the first labyrinth seal wall and the second labyrinth seal wall are arranged movably with respect to one another, wherein the first labyrinth seal wall is arranged stationarily and the second labyrinth seal wall is arranged movably, or the first labyrinth seal wall is arranged movably and the second labyrinth seal wall is arranged stationarily, or the first labyrinth seal wall is arranged movably and the second labyrinth seal wall is arranged movably.

It is further provided according to a preferred further development of the labyrinth seal device that the first labyrinth seal wall is formed by a generator housing and/or nacelle housing and/or machine housing and/or a spinner.

Additionally or alternatively, it is provided in a preferred further development of the labyrinth seal device that the second labyrinth seal wall is formed by a generator housing and/or nacelle housing and/or machine housing and/or a spinner.

Additionally or alternatively, it is provided in a preferred further development of the labyrinth seal device that the sealing section has a constant cross-sectional area, wherein the cross-sectional area of the sealing section preferably does not change, in particular does not increase and/or does not decrease, in the flow direction.

According to a further aspect, provided is an air passage described at the beginning having a labyrinth seal device according to the aspect described above and/or the preferred embodiments thereof described above.

According to a further aspect, provided is a generator described at the beginning having a labyrinth seal device and/or an air passage according to one and/or both of the aspects described above and/or the preferred embodiments of the respective aspects.

According to a further aspect, provided is a wind power installation described at the beginning having a labyrinth seal device and/or an air passage and/or a generator according to one and/or all of the aspects described above and/or the preferred embodiments of the respective aspects.

According to a further aspect, provided is a method of using a labyrinth seal device according to the aspect described above and/or the preferred embodiments thereof described above for the flow-optimized sealing of an air passage for cooling air of a cooling system for a generator of a wind power installation.

For the advantages, embodiment variants and embodiment details of these further aspects of the disclosure and their further developments, reference is also made to the preceding description relating to the corresponding features of the labyrinth seal device or of the respective other aspects.

Embodiments of the disclosure will now be described hereinbelow with reference to the drawings. The drawings are not necessarily intended to show the embodiments to scale but rather, where this is beneficial for explanation purposes, the drawings are in schematic and/or slightly distorted form. With regard to additions to the teaching which is discernible directly from the drawings, reference is made to the relevant prior art. It should be noted that many different modifications and changes concerning the form and detail of an embodiment can be made without departing from the general idea of the disclosure. The features of the disclosure that are disclosed in the description, in the drawings and in the claims can be essential for the development of the disclosure both individually and in any desired combination. In addition, all combinations of at least two of the features disclosed in the description, the drawings and/or the claims fall within the scope of the disclosure. The general idea of the disclosure is not limited to the exact form or the detail of the preferred embodiments shown and described in the following text or limited to subject matter which would be restricted compared to the subject matter claimed in the claims. Where ranges of measurements are given, values lying within the mentioned limits are also to be disclosed as limit values and are to be usable and claimable as desired. For the sake of simplicity, the same reference signs are used hereinbelow for identical or similar parts or parts having an identical or similar function.

### BRIEF DESCRIPTION OF THE SEVERAL VIEWS OF THE DRAWINGS

Further advantages, features and details of the disclosure will become apparent from the following description of the preferred embodiments and with reference to the drawings, in which:

FIG. 1 shows a schematic, three-dimensional view of an exemplary embodiment of a wind power installation;

FIG. 2 shows a schematic, sectional view of a first preferred embodiment of a labyrinth seal device;

FIG. 3 shows a schematic, sectional view of a further preferred embodiment of a labyrinth seal device;

FIG. 4 shows a schematic, sectional view of a further preferred embodiment of a labyrinth seal device;

FIG. 5 shows a schematic, sectional view of a further preferred embodiment of a labyrinth seal device; and

FIG. 6 shows a schematic, three-dimensional view of an exemplary embodiment.

In the figures, elements which are the same or have substantially the same function are provided with the same reference signs. General descriptions generally relate to all the embodiments, unless differences are explicitly indicated.

### DETAILED DESCRIPTION

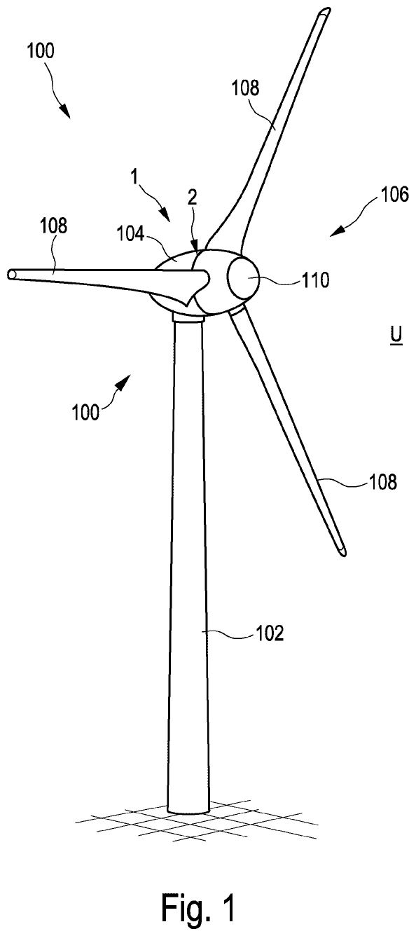

The explanation of the disclosure by means of examples with reference to the figures is made substantially schematically, and the elements which are explained in the respective figure may be exaggerated therein for the purpose of better illustration and other elements may be simplified. For example, FIG. 1 shows a wind power installation as such schematically, so that the generator, the air passage and the labyrinth seal device cannot be seen in detail.

FIG. 1 shows a schematic, three-dimensional view of a wind power installation 100. The wind power installation 100 has a tower 102 and a nacelle 104 on the tower 102. The tower 102 can consist of tower segments arranged next to one another. On the nacelle 104 there is provided an aerodynamic rotor 106 having three rotor blades 108 and a spinner 110. During operation of the wind power installation 100, the aerodynamic rotor 106 is set into a rotational movement by the wind W and thus also rotates an electrodynamic rotor of a generator 1, which is coupled directly or indirectly with the aerodynamic rotor 106. The generator 1 is arranged in the nacelle 104 and generates electrical energy.

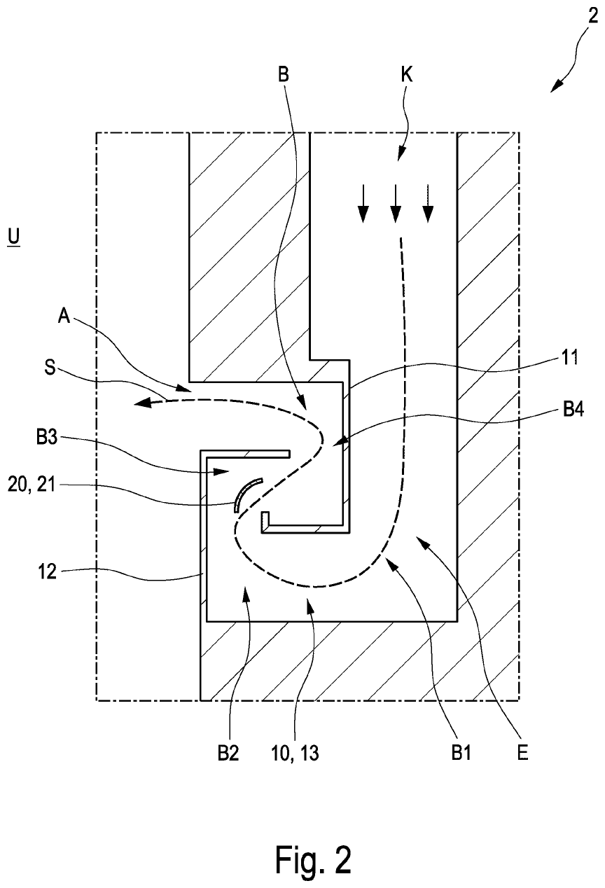

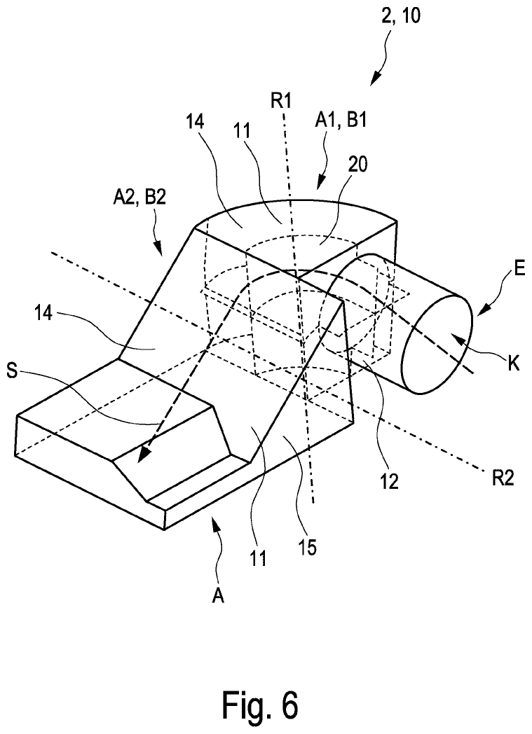

FIGS. 2 to 6 show air passages 2 of a generator 1 with different preferred embodiments of a labyrinth seal device 10. In FIGS. 2 to 5, the air passage 2 is in the form of an air outlet. In FIG. 6, the air passage 2 is in the form of an air inlet.

It can be seen in FIGS. 2 to 6 that cooling air K of a cooling system is guided through the air passage 2 and accordingly through the labyrinth seal device 10 of the respective embodiment. In FIGS. 2 to 5, it will be appreciated that cooling air K warmed by the generator is guided through the air outlet, or the labyrinth seal device 10, through an air inlet opening E out of the generator interior and through an outlet opening A into the surrounding area U, in order to ensure cooling of the generator 1, so that cooling air K from the surrounding area U is correspondingly able to flow in via an air inlet to cool the generator 1. This is shown in the exemplary embodiment shown in FIG. 6. FIG. 6 shows an air inlet through which cooling air K from the surrounding area U is guided into the generator interior to cool the generator 1. It is thus apparent from FIGS. 2 to 6 that the labyrinth seal device 10 fluidically connects the surrounding area U of the generator 1 with a generator interior of the generator 1 in order to cool the generator 1.

The embodiments of labyrinth seal devices 10 shown schematically in FIGS. 2 to 5 each have a first and a second labyrinth seal wall 11, 12. The first and second labyrinth seal walls 11, 12 are arranged spaced apart from one another, so that cooling air K can be guided between the first and second labyrinth seal walls 11, 12. The first and second labyrinth seal walls 11, 12 are arranged relative to one another such that they form a labyrinthine sealing section 13. In the preferred embodiments, it is provided that the first labyrinth seal wall 11 is a fixed component and the second labyrinth seal wall 12 is a rotating component. The labyrinthine form of the sealing section 13 allows the generator 1 to be sealed with respect to dirt and/or water from the surrounding area U. The labyrinthine sealing sections 13 of the embodiments of the labyrinth seal devices 10 shown schematically in FIGS. 2 to 5 are characterized in that they cause at least one change in the flow direction of the cooling air K.

It will be appreciated that the labyrinthine sealing section 13 is not absolutely air-tight but fluidically connects the surrounding area U of the generator 1 with a generator interior of the generator 1 for cooling the generator 1. Nevertheless, the at least one change in the flow direction of the cooling air K causes the generator 1 to be sealed with respect to dirt and/or water from the surrounding area U.

In order to cool the generator as efficiently as possible with cooling air K despite the labyrinthine sealing section 13, the sealing section 13 has an air directing device 20 which is configured to direct the cooling air K through the sealing section 13 in a flow-optimized manner. FIGS. 2 to 6 show different preferred embodiments of the labyrinth seal device 10 which allow the cooling air K to be guided through the sealing section 13 from the inlet opening E to the outlet opening A in a flow-optimized manner.

FIGS. 2 to 4 show preferred labyrinth seal devices 10 in which the air directing device 20 within the sealing section 13 is arranged spaced apart from the first and second labyrinth seal walls 11, 12. It is provided that the cooling air K enters the labyrinth seal device 10 through the inlet opening E. It can be seen that the first labyrinth seal wall 11 has a first deflection region B1 in the region of the inlet opening E. In the first deflection region, the sealing section 13 forces a change in the flow direction S of the cooling air K through about 90° about a first deflection axis. Downstream of the first deflection region, in a second deflection region B2, the sealing section 13 forces a further change in the flow direction S of the cooling air K through about 90° about a second deflection axis. In a third deflection region B3, a deflection of the cooling air K through 45° to 90° about a third deflection axis is caused. In a fourth deflection region B4, which extends between the third deflection region and the outlet opening A, the flow direction of the cooling air is deflected between 270° and 360° about a fourth deflection axis. It will be appreciated that the first, second, third and fourth deflection axes extend substantially parallel to and spaced apart from one another.

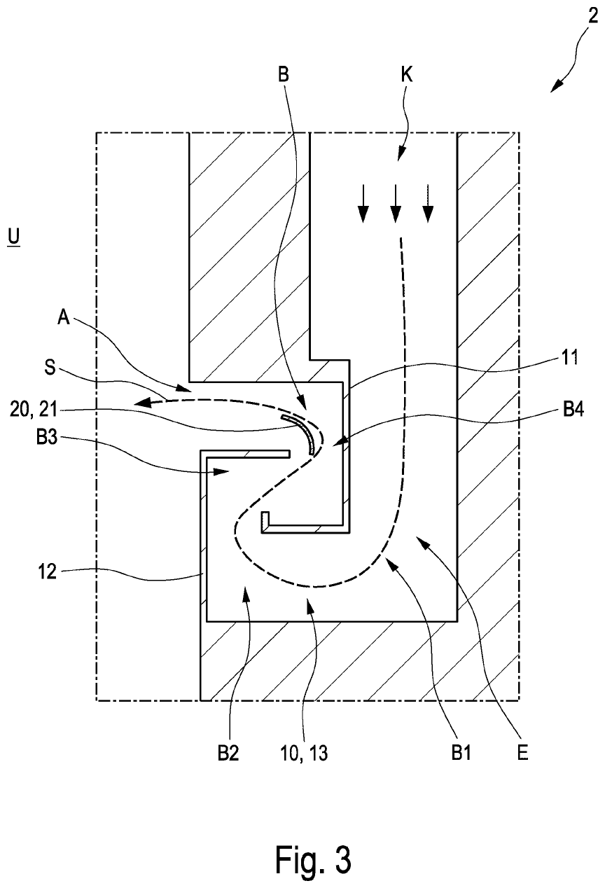

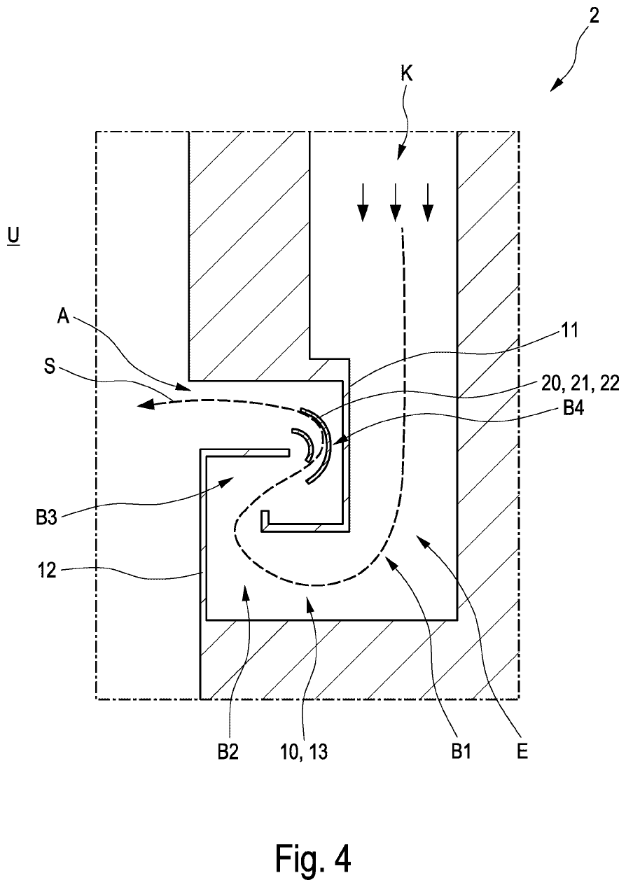

The preferred embodiments of the labyrinth seal devices 10 shown in FIGS. 2 to 4 differ substantially in the arrangement and form of the air directing device 20. In the embodiment shown in FIG. 2, an arrangement of the air directing device 20 in the third deflection region is provided for flow-optimized guiding of the cooling air K. The air directing device 20 has a curved air directing element 21, which is in the form of an air baffle, and deflects the cooling air in a flow-optimized manner through 90° about a third deflection axis. In the embodiment shown in FIG. 3, an arrangement of the air directing device 20 in the fourth deflection region B4 is provided for flow-optimized guiding of the cooling air K. The air directing device 20 has a curved air directing element 21, which is in the form of an air baffle, and deflects the cooling air in a flow-optimized manner through 90° about a fourth deflection axis. The embodiment shown in FIG. 4 is based on the embodiment of the labyrinth seal device 10 shown in FIG. 3. The embodiment shown in FIG. 4 differs from the embodiment shown in FIG. 3 only in that the air directing device 20 has two air directing elements arranged parallel to and spaced apart from one another, which deflect the cooling air in a flow-optimized manner through 180° about a fourth deflection axis. By arranging the two air directing elements 21 side by side in the flow direction S, particularly flow-optimized guiding of the cooling air K is made possible.

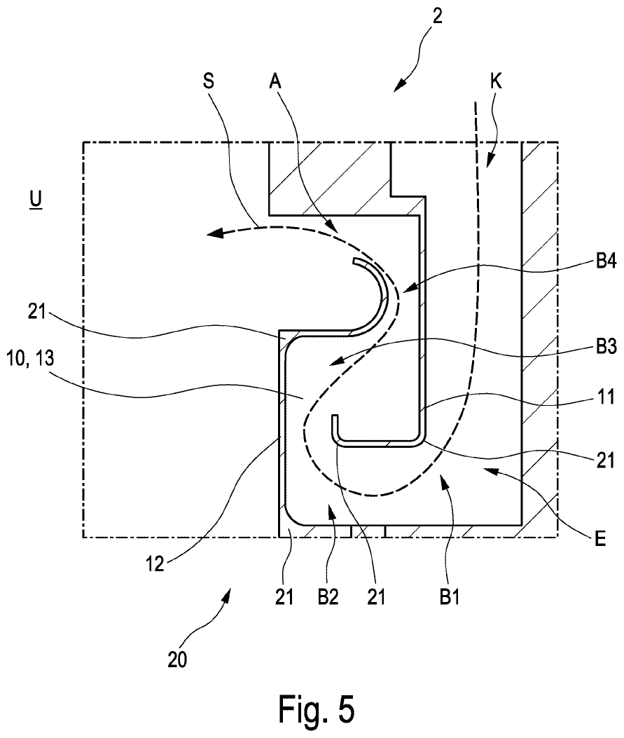

FIG. 5 shows a labyrinth seal device 10 in which the air directing device 20 is formed on the first and second labyrinth seal walls 11, 12. It is further provided in this preferred embodiment that the air directing device 20 has a plurality of air directing elements 21 which are arranged one behind the other in the flow direction S.

It can be seen that the first labyrinth seal wall 11 forms in the region of the inlet opening E in a first deflection region B1 a wall portion having a curvature, which allows the cooling air K to flow in a flow-optimized manner into the sealing section 13. In the region of the inlet opening E, the wall portion of the first labyrinth seal wall 11 follows a profile of a quadrant. In relation to the inlet, a first change of direction of the flow direction S of the cooling air K through about 90° then takes place in a second deflection region B2. In this second deflection region B2, both the first and the second labyrinth seal walls 11, 12 have a curved, that is to say convex or concave, wall portion, which allows the cooling air K to be deflected in a flow-optimized manner. In the second deflection region B2, both the first and the second labyrinth seal walls 11, 12 follow a profile of a quadrant. In a third deflection region B3, only the second labyrinth seal wall 12 has a curved wall portion, which likewise follows the profile of a quadrant. Finally, the sealing section 13 has a fourth deflection region B4. In this region, the first labyrinth seal wall 11 is straight and the second labyrinth seal wall 12 forms a curved wall portion which follows a profile of a semicircle. Owing to the specific form of the third and fourth deflection regions B3, B4, the flow direction S of the cooling air K changes from the third deflection region B3 to the fourth deflection region B4 by about 45°. The cooling air is then again deflected through 90° by means of the fourth deflection region B4, before the cooling air leaves the sealing section 13 through an outlet opening A.

It can further be seen that the first labyrinth seal wall 11 and the second labyrinth seal wall 12 are arranged substantially parallel to and spaced apart from one another along the sealing section in the region of the first and second deflection regions B. In the region of the third and fourth deflection regions B3, B4, the first labyrinth seal wall 11 and the second labyrinth seal wall 12 are arranged substantially non-parallel to and spaced apart from one another along the sealing section 13.

FIG. 6 shows an air inlet in the form of an air passage 2 for a generator 1 having a tubular labyrinth seal device 10 which extends between an inlet opening E and an outlet opening A. Through the air inlet, cooling air K is guided from the surrounding area U into the generator interior in order to cool a generator 1.

The tubular labyrinth seal device 10 has a labyrinthine sealing section 13 which is divided into a first portion A1 and a second portion A2 which is different from the first portion A1. In the first portion A1, the flow direction S of the cooling air K is deflected about a first deflection axis R1. In the second portion, the flow direction S of the cooling air K is deflected about a second deflection axis R2 which is different from the first deflection axis R1. The second deflection axis R2 is here oriented so that it is rotated through about 90° relative to the first deflection axis R1.

The tubular labyrinth seal device 10 has in the first portion A1 three labyrinth seal walls, a first, a second and a third labyrinth seal wall 11, 12, 14. The three labyrinth seal walls 11, 12, 14 are arranged in this first portion A1 such that they form, orthogonal to the flow direction S, a labyrinthine sealing section 13 with a square cross-section. To this end, the first and second labyrinth seal walls 11, 12 are in the form of quadrant segments, which are arranged parallel to and spaced apart from one another. The first and second labyrinth seal walls 11, 12 are connected together by the third labyrinth seal wall 14, which extends along the sealing section 13 following a profile of a quadrant. In this respect, the tubular labyrinth seal device 10 defines a sealing section 13 which, in a first deflection region B1 starting from the inlet opening E, first causes a change of direction of the flow direction S of the incoming cooling air K through about 90° about the first deflection axis R1.

For flow optimization, an air directing device 20 is arranged within the sealing section 13 in the first portion A1. The air directing device 20 has two air directing elements 21, which are arranged in the shape of a cross. It is here provided that one air directing element 21 extends within the sealing section 13 centrally between and parallel to the first and second labyrinth seal walls 11, 12. The other air directing element 21 is likewise arranged within the sealing section 13 parallel to and spaced apart from the third labyrinth seal wall 14.

In the second portion, the tubular labyrinth seal device 10 additionally has a fourth labyrinth seal wall 15. In the second portion A2, the first labyrinth seal wall 11 is arranged at an angle relative to the second labyrinth seal wall 12, so that the rectangular cross-section of the sealing section 13 in the second portion A2, through which the cooling air K flows, decreases in the direction toward the outlet opening A. In this respect, the air directing device 20 in the second portion A2 is formed on the first labyrinth seal wall 11 as an air directing element 21. The third and fourth labyrinth seal walls 15 are triangle shaped and arranged parallel to and spaced apart from one another. By means of this configuration, the flow direction S of the cooling air K is changed by about 45° about the second deflection axis R2 in the second portion A2.

### LIST OF REFERENCE SIGNS

1 generator
2 air passage
10 labyrinth seal device
11 first labyrinth seal wall
12 second labyrinth seal wall
13 labyrinthine sealing section
14 third labyrinth seal wall
15 fourth labyrinth seal wall
20 air directing device
21 air directing element
22 air directing unit
100 wind power installation
A outlet opening
A1, A2 portions of the sealing section
B, B1, B2, B3, B4 deflection regions
E inlet opening
K cooling air
R1 first deflection axis
R2 second deflection axis
S flow direction
U surrounding area

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A labyrinth seal device for cooling air of a cooling system of a generator of a wind power installation, the labyrinth seal device comprising:
a first labyrinth seal wall and a second labyrinth seal wall arranged spaced apart from the first labyrinth seal wall, wherein:
the first and second labyrinth seal walls form a labyrinthine sealing section configured to seal the generator with respect to dirt and/or water from a surrounding area and to fluidically connect the surrounding area of the generator with a generator interior of the generator to cool the generator,
the labyrinthine sealing section has an air directing device configured to direct the cooling air in a flow-optimized manner through the labyrinthine sealing section.

2. The labyrinth seal device as claimed in claim 1, wherein the air directing device is:
arranged within the labyrinthine sealing section spaced apart from the first and/or second labyrinth seal wall, and/or
on the first and/or second labyrinth seal wall.

3. The labyrinth seal device as claimed in claim 2, wherein the air directing device has at least one air directing element.

4. The labyrinth seal device as claimed in claim 3, wherein the air directing device has a plurality of air directing elements, wherein the plurality of air directing elements are arranged one behind the other or side by side in a flow direction of cooling air.

5. The labyrinth seal device as claimed in claim 3, wherein the at least one air directing element is at least one of curved or inclined.

6. The labyrinth seal device as claimed in claim 5, wherein the at least one air directing element is arranged relative to the flow direction.

7. The labyrinth seal device as claimed in claim 3, wherein the at least one air directing element is a part-ring segment which extends up to 180°.

8. The labyrinth seal device as claimed in claim 1, wherein the labyrinthine sealing section has at least one deflection region configured to guide cooling air such that the at least one deflection region causes a change in a flow direction of the cooling air.

9. The labyrinth sealing device as claimed in claim 8, wherein the labyrinthine sealing section has at least two deflection regions configured to bring about a change in flow direction, wherein the change in flow direction is up to 180°, wherein at least two deflection regions are arranged in series in the flow direction.

10. The labyrinth seal device as claimed in claim 3, wherein the at least one air directing elements is arranged in a deflection region, wherein the at least two air directing elements are arranged side by side orthogonal to the flow direction and/or at least two air directing elements arranged one behind the other in the flow direction and form an air directing unit.

11. The labyrinth seal device as claimed in claim 10, wherein at least one directing element or an air directing unit is arranged in at least one of the deflection regions.

12. The labyrinth seal device as claimed in claim 1, wherein:
the first labyrinth seal wall and the second labyrinth seal wall are arranged stationarily with respect to one another, or
the first labyrinth seal wall and the second labyrinth seal wall are arranged movably with respect to one another, wherein:
the first labyrinth seal wall is arranged stationarily and the second labyrinth seal wall is arranged movably, or
the first labyrinth seal wall is arranged movably and the second labyrinth seal wall is arranged stationarily, or
the first labyrinth seal wall is arranged movably and the second labyrinth seal wall is arranged movably.

13. The labyrinth seal device as claimed in claim 1, wherein at least one of the first or second labyrinth seal wall is formed by a component from a list including a generator housing, a nacelle housing, a machine housing, and a spinner.

14. The labyrinth seal device as claimed in claim 12 wherein the labyrinthine sealing section has a constant cross-sectional area in the flow direction.

15. An air passage comprising the labyrinth seal device as claimed in claim 1.

16. A generator comprising an air passage, and a labyrinth seal device as claimed in claim 1 in the air passage.

17. A wind power installation comprising a generator, and a labyrinth seal device as claimed in claim 1.

18. A method of using the labyrinth seal device as claimed in claim 1, comprising: guiding cooling air in an air passage of the cooling system for the generator of the wind power installation.
